(19) United States
(12) Patent Application Publication
(10) Pub. No.: US 2007/0126676 A1
(43) Pub. Date: Jun. 7, 2007

(54) COLOR FILTER SUBSTRATE, LIQUID CRYSTAL DISPLAY PANEL AND LIQUID CRYSTAL DISPLAY DEVICE HAVING THE SAME, AND METHOD THEREOF

(75) Inventors: Jae-Hyun KIM, Suwon-si (KR); Jun-Young LEE, Yongin-si (KR); Sung-Wook KANG, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/561,928

(22) Filed: Nov. 21, 2006

(30) Foreign Application Priority Data
Dec. 7, 2005 (KR) 2005118471

(51) Int. Cl. G09G 3/36

(52) U.S. Cl. 345/88

(57) ABSTRACT

A color filter substrate includes a base substrate, a first common electrode layer, a second common electrode layer, and a color filter layer. The base substrate includes a plurality of pixel parts. The first common electrode layer is on the base substrate and receives a first voltage. The second common electrode layer faces the first common electrode and receives a second voltage. The color filter layer is interposed between the first and second common electrode layers, and includes a plurality of electrochromic patterns corresponding to the pixel parts, respectively. A color purity of the color filter layer is changed based on the first and second voltages. The color filter layer displays an image of high color purity in a first mode transmitting a first light, and displays an image of low color purity in a second mode transmitting a second light. Therefore, a color reproducibility is improved.

The present application claims priority to Korean Patent Application No. 2005-118471, filed on Dec. 7, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a color filter substrate, a liquid crystal display (“LCD”) panel having the color filter substrate, an LCD device having the color filter substrate, and a method thereof. More particularly, the present invention relates to a color filter substrate capable of controlling color reproducibility with respect to a reflection mode and a transmission mode, an LCD panel having the color filter substrate, an LCD device having the color filter substrate, and a method of controlling color reproducibility of the color filter substrate.

2. Description of the Related Art

A liquid crystal display (“LCD”) device, in general, is classified into a transmissive type LCD device and a transflective type LCD device. The transmissive type LCD device transmits light to display an image. The transflective type LCD device transmits an internally provided light, such as from a backlight assembly, and reflects an externally provided light to display an image on a display panel.

A pixel part of the transflective LCD device includes a transmission region and a reflection region. The internally provided light passes through the transmission region, and the externally provided light passes through the reflection region. Thus, the transflective LCD device has a transmission mode and a reflection mode. In the transmission mode, the image is displayed using the internally provided light. In the reflection mode, the image is displayed using the externally provided light.

A color reproducibility of the transmission mode, in general, is smaller than that of the reflection mode. The color reproducibility of the reflection mode is decreased, as a reflectivity of the reflection region is increased. In order to increase the color reproducibility of the reflection mode and the reflectivity of the reflection region, a light hole is formed in a color filter pattern in a color filter substrate in the reflection region.

However, when the color filter pattern has the light hole, a stepped portion is formed in the color filter substrate adjacent to the light hole. A conventional transflective LCD device includes an overcoating layer to planarize the color filter pattern having the light hole. However, the overcoating layer is formed along the color filter pattern having the light hole so that a recess is formed on the light hole.

### BRIEF SUMMARY OF THE INVENTION

The present invention provides a color filter substrate capable of controlling color reproducibility with respect to a reflection mode and a transmission mode.

The present invention also provides a liquid crystal display (“LCD”) panel having the above-mentioned color filter substrate.

The present invention also provides an LCD device having the color filter substrate.

The present invention also provides a method of controlling color reproducibility of the color filter substrate.

A color filter substrate in accordance with exemplary embodiments of the present invention includes a base substrate, a first common electrode layer, a second common electrode layer, and a color filter layer. The base substrate includes a plurality of pixel parts. The first common electrode layer is on the base substrate and receives a first voltage. The second common electrode layer faces the first common electrode and receives a second voltage. The color filter layer is interposed between the first and second common electrode layers, and includes a plurality of electrochromic patterns corresponding to the pixel parts, respectively. A color purity of the color filter layer is changed based on the first and second voltages. The color filter layer displays an image of high color purity in a first mode transmitting a first light, and displays an image of low color purity in a second mode transmitting a second light.

An LCD panel in accordance with other exemplary embodiments of the present invention includes an array substrate, a color filter substrate, and a liquid crystal layer. The array substrate includes a plurality of pixel parts, and each of the pixel parts includes a switching element, a transparent electrode, and a reflecting electrode. The transparent and reflecting electrodes are electrically connected to the switching element. The color filter substrate faces the array substrate, and includes a first common electrode, a second common electrode, and an electrochromic layer. The second common electrode faces the first common electrode. The electrochromic layer is interposed between the first and second common electrodes. A color purity of the color filter layer is changed based on a voltage difference between the first and second common electrodes. The liquid crystal layer is interposed between the array substrate and the color filter substrate.

An LCD device in accordance with still other exemplary embodiments of the present invention includes an LCD panel, a light source module, and a driving voltage generating part. The LCD panel includes an array substrate, a color filter substrate, and a liquid crystal layer. The array substrate includes a switching element and a pixel part. The pixel part has a transparent electrode and a reflecting electrode, and the transparent and reflecting electrodes are electrically connected to the switching element. The color filter substrate faces the array substrate, and includes a first common electrode, a second common electrode facing the first common electrode, and an electrochromic pattern interposed between the first and second common electrodes. The liquid crystal layer is interposed between the array substrate and the color filter substrate. The light source module is on a rear surface of the LCD panel and supplies the LCD panel with a first light. The driving voltage generating part applies voltages to the first and second common electrodes so that the electrochromic pattern has high color purity in a transmission mode transmitting the first light through the transparent electrode to display an image.

A method in accordance with still other exemplary embodiments of the present invention includes a method of controlling color reproducibility of a color filter substrate of a transflective liquid crystal display panel, the color filter substrate having a first common electrode layer, a second common electrode layer, and an electrochromic layer interposed between the first and second common electrode layers, the method including applying a first voltage to the first common electrode layer of the color filter substrate, and applying a second voltage to the second common electrode layer of the color filter substrate, wherein the first voltage has a greater level than the second voltage in a transmission mode of the transflective liquid crystal panel, and the second voltage has a greater level than the first voltage in a reflection mode of the transflective liquid crystal panel.

According to the present invention, the color purity of a color filter substrate is adjusted in response to a voltage applied thereto to improve a color reproducibility of the reflection mode and the transmission mode.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a cross-sectional view illustrating an exemplary color filter substrate in accordance with an exemplary embodiment of the present invention;

FIGS. 2 and 3 are cross-sectional views illustrating an operation of the exemplary color filter substrate shown in FIG. 1;

FIG. 4 is a plan view illustrating an exemplary transflective LCD panel in accordance with another exemplary embodiment of the present invention;

FIG. 5 is a cross-sectional view taken along line I-I′ shown in FIG. 4;

FIG. 6 is a cross-sectional view illustrating a transmission mode of the exemplary transflective LCD panel shown in FIG. 5;

FIG. 7 is a cross-sectional view illustrating a reflection mode of the exemplary transflective LCD panel shown in FIG. 5; and

FIG. 8 is a block diagram illustrating an exemplary LCD device in accordance with another exemplary embodiment of the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be further described with reference to the accompanying drawings.

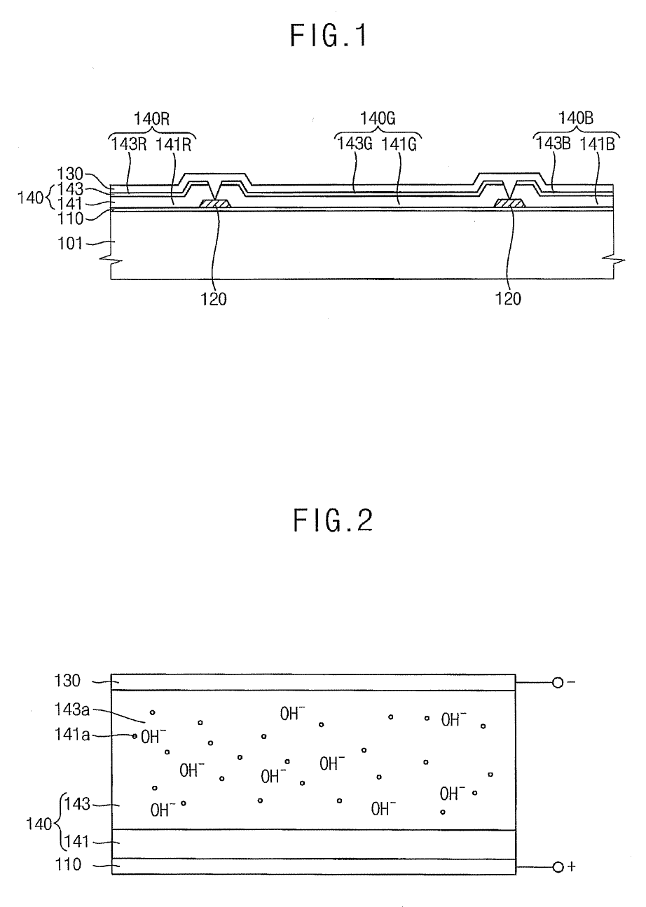

FIG. 1 is a cross-sectional view illustrating an exemplary color filter substrate in accordance with an exemplary embodiment of the present invention.

Referring to FIG. 1, the color filter substrate includes a base substrate 101, a first common electrode layer 110, a black matrix 120, a second common electrode layer 130, and a color filter layer 140.

The base substrate 101 includes a transparent material, such as glass, that transmits light.

The first common electrode layer 110 includes a transparent conductive material. The first common electrode layer 110 is formed on the base substrate 101, and a first voltage is applied to the color filter layer 140 through the first common electrode layer 110.

The black matrix 120 defines a plurality of regions on the base substrate 101, and blocks light. In FIG. 1, the black matrix 120 is formed on the first common electrode layer 110. Alternatively, the black matrix 120 may be formed on the base substrate 101, and the first common electrode layer 110 may be formed on the black matrix 120 and on exposed portions of the base substrate 101.

The second common electrode layer 130 is formed on the color filter layer 140 so that a second voltage is applied to the color filter layer 140 through the second common electrode layer 130.

The color filter layer 140 includes an electrochromic film that changes color in response to an electric field applied thereto. The color filter layer 140 includes a solvent layer 141 having a plurality of pigment particles, and an electrolyte layer 143 adjacent to the second common electrode layer 130 to generate a plurality of mobile ions based on the electric field.

The color filter layer 140 includes a first electrochromic pattern 140R having a red solvent layer 141R including red pigment and an electrolyte area 143R, a second electrochromic pattern 140G having a green solvent layer 141G including green pigment and an electrolyte area 143G, and a third electrochromic pattern 140B having a blue solvent layer 141B including blue pigment and an electrolyte area 143B.

The electrolyte layer 143 includes an electrolyte material that has mobile ions. Examples of the mobile ions that can be used for the electrolyte layer 143 include lithium ion (Li+), hydrogen ion (H+), sodium ion (Na+), hydroxyl ion (OH—), etc.

When a first electric field is applied to the color filter layer 140, the electrolyte layer 143 of the color filter layer 140 is electrolyzed to generate the mobile ions so that ion density of the solvent layer 141 is increased by the mobile ions, thereby increasing color purity of the color filter layer 140. When a second electric field is applied to the color filter layer 140, such as an electric field smaller than the first electric field, the electrolyte layer 143 of the color filter layer 140 is not electrolyzed so that the mobile ions are not generated. Thus, the ion density of the solvent layer 141 is decreased so that the color purity is decreased.

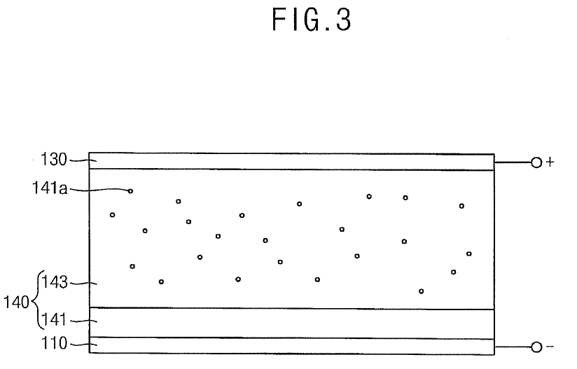

FIGS. 2 and 3 are cross-sectional views illustrating an operation of the exemplary color filter substrate shown in FIG. 1.

Referring to FIGS. 2 and 3, the color filter layer 140 includes the first common electrode layer 110 and the second common electrode layer 130. The first common electrode layer 110 is on a first surface of the color filter layer 140, one of the solvent layer 141 and the electrolyte layer 143, and the second common electrode layer 130 is on a second surface of the color filter layer 140, the other of the solvent layer 141 and the electrolyte layer 143. In the illustrated embodiment, the first common electrode layer 110 is adjacent the solvent layer 141 and the second common electrode layer 130 is adjacent the electrolyte layer 143.

The color filter layer 140 includes the solvent layer 141 and the electrolyte layer 143. The solvent layer 141 includes the pigment particles 141a, and the electrolyte layer 143 generates the mobile ions 143a. While the illustrated embodiment depicts mobile hydroxyl ions (OH—) 143a, it should be understood that alternate mobile ions would also be within the scope of these embodiments. The electrolyte layer 143 is adjacent to one of the first and second common electrode layers 110 and 130. In FIG. 2, the electrolyte layer 143 includes the electrolyte material that generates mobile hydroxyl ions (OH—), and is adjacent to the second common electrode layer 130.

In FIG. 2, when a first voltage (+) applied to the first common electrode layer 110 has a greater level than a second voltage (−) applied to the second common electrode layer 130, the electrolyte layer 143 is electrolyzed. The electrolyzed electrolyte layer 143 generates the mobile hydroxyl ions (OH—) 143a. The mobile hydroxyl ions (OH—) 143a are transported toward the solvent layer 141 adjacent to the first common electrode layer 110.

When the mobile hydroxyl ions (OH—) 143a are transported into the solvent layer 141, the ion density of the solvent layer 141 is increased so that the color purity of the color filter layer 140 is increased.

In a transmission mode of a transflective LCD device, a first light L1 passes through an LCD panel one time. In a reflection mode of the transflective LCD device, a second light L2 passes through the LCD panel two times. Thus, the color purity in the transmission mode is greater than the color purity in the reflection mode.

Therefore, when the color purity of the color filter layer 140, which may also be termed the “electrochromic layer”, is increased, the color filter layer 140 having the increased color purity corresponds to the transmission mode.

In FIG. 3, when the first voltage (−) applied to the first common electrode layer 110 has a smaller level than the second voltage (+) applied to the second common electrode layer 130, the electrolyte layer 143 is not electrolyzed. Thus, the electrolyte layer 143 does not generate the mobile hydroxyl ions (OH—) 143a as in the operation shown in FIG. 2.

When the electrolyte layer 143 does not generate the mobile hydroxyl ions (OH—) 143a, the ion density of the solvent layer 141 is decreased so that the color purity of the color filter layer 140 in FIG. 3 is smaller than that of FIG. 2.

Therefore, when the color purity of the color filter layer 140 is small, the color filter layer 140 having the small color purity corresponds to the reflection mode.

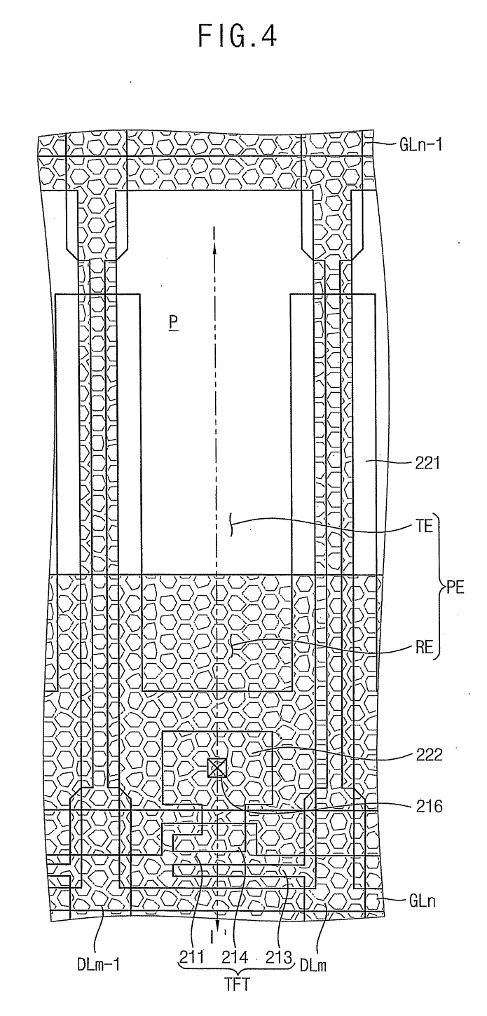

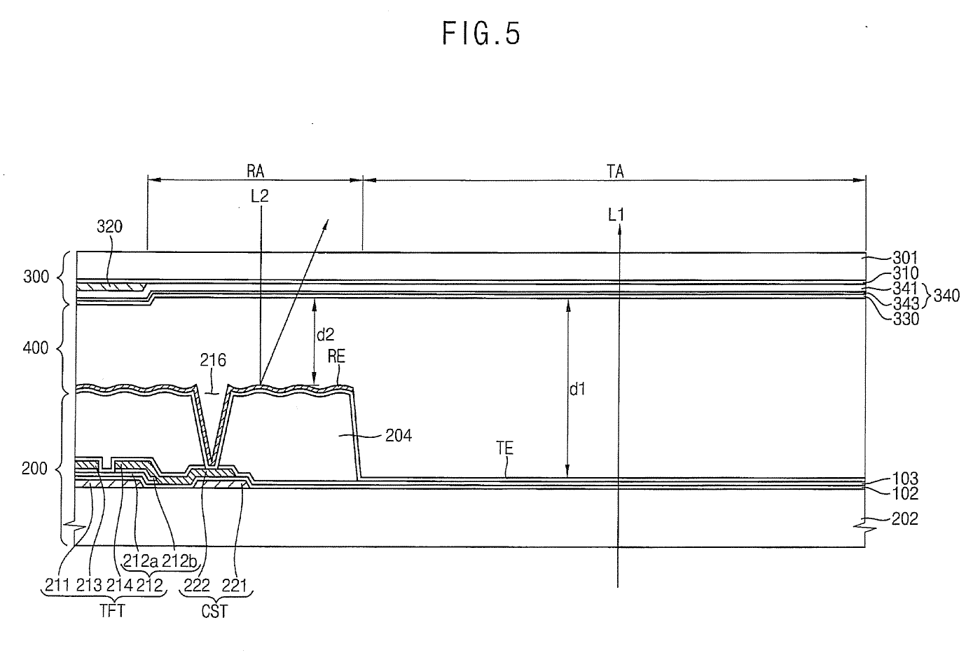

FIG. 4 is a plan view illustrating an exemplary transflective LCD panel in accordance with another exemplary embodiment of the present invention. FIG. 5 is a cross-sectional view taken along line I-I′ shown in FIG. 4.

Referring to FIGS. 4 and 5, the transflective LCD panel includes an array substrate 200, a color filter substrate 300, and a liquid crystal layer 400. The color filter substrate 300 faces the array substrate 200. The liquid crystal layer 400 is interposed between the array substrate 200 and the color filter substrate 300.

The transflective LCD panel includes a plurality of pixel parts P. The pixel parts P are defined by a plurality of source lines DLm-1 and DLm, also referred to as data lines, and a plurality of gate lines GLn-1 and GLn.

Each pixel part P includes a switching element TFT such as a thin film transistor, a transparent electrode TE, a reflecting electrode RE, a storage capacitor CST, a first electrode 310, a black matrix 320, a second electrode 330, and an electrochromic pattern 340. The switching element TFT, the transparent electrode TE, the reflecting electrode RE, and the storage capacitor CST are formed on the array substrate 200. The first electrode 310, the black matrix 320, the second electrode 330, and the electrochromic pattern 340 are formed on the color filter substrate 300.

The switching element TFT is formed on a first base substrate 202, and includes a gate electrode 211 electrically connected to an n-th gate line GLn, a source electrode 213 electrically connected to an m-th source line DLm, and a drain electrode 214 electrically connected to the transparent electrode TE and the reflecting electrode RE.

The n-th gate line GLn and the gate electrode 211 are formed from a gate metal layer. A gate insulating layer 102 is formed on the n-th gate line GLn and the gate electrode 211, as well as on a storage common line 221 as will be further described below. A channel layer 212 having an active layer 212a and an ohmic contact layer 212b is formed on the gate insulating layer 102. The source and drain electrodes 213 and 214 are formed on the channel layer 212. The source and drain electrodes 213 and 214 and the m-th source line DLm are formed from a source metal layer.

A passivation layer 103 and an organic insulating layer 204 are formed on the switching element TFT. A contact hole 216 is formed through the passivation layer 103 and the organic insulating layer 204. A metal pattern 222 is an extension of the drain electrode 214, and the metal pattern 222 is partially exposed through the contact hole 216. Thus, the transparent electrode TE is electrically connected to the drain electrode 214 through the contact hole 216.

Particularly, the transparent electrode TE is formed on substantially an entire area of each of the pixel parts P. The reflecting electrode RE is formed on a portion of the transparent electrode TE. That is, the pixel electrode PE of each of the pixel parts P includes the transparent electrode TE and the reflecting electrode RE. Each of the pixel parts P is divided into a transmission region TA and a reflection region RA by the reflecting electrode RE. The organic insulating layer 204 corresponds to the reflection region RA, and is interposed between the switching element TFT and the transparent electrode TE.

Thus, the portions of the liquid crystal layer 400 in the transmission region TA of each of the pixel parts P has different cell-gaps from the portions of the liquid crystal layer 400 in the reflection region RA of each of the pixel parts P. A first cell-gap d1 is formed in the transmission region TA and a second cell-gap d2 is formed in the reflection region RA. The first cell-gap d1 of the transmission region TA and the second cell-gap d2 of the reflection region RA are determined by a path length of the first light L1 passing through the transmission region TA and a path length of the second light L2 passing through the reflection region RA. For example, the first cell-gap d1 is about twice the second cell-gap d2.

In the transmission mode of the transflective LCD device, the first light L1, such as from a backlight assembly, that is incident into the transmission region TA from a rear surface of the transflective LCD device passes through the transmission region TA. In the reflection mode of the transflective LCD device, the second light L2, such as from an exterior of the LCD device, that is incident into the reflection region RA from a front surface of the transflective LCD device is reflected from the reflection region RA.

The storage capacitor CST includes a storage common line 221 and a metal pattern 222. The storage common line 221 is formed in the pixel parts P. The metal pattern 222 is partially overlapped with the storage common line 221. The gate insulating layer 102 is interposed between the storage common line 221 and the metal pattern 222. The metal pattern 222 is extended from the drain electrode 214, and the contact hole 216 is formed to expose the metal pattern 222.

The first electrode 310, the black matrix 320, the second electrode 330 and the electrochromic pattern 340 are formed on the color filter substrate 300 corresponding to each of the pixel parts P.

The first electrode 310 is formed on a second base substrate 301. A first voltage is applied to the electrochromic pattern 340 through the first electrode 310.

The black matrix 320 is formed on the first electrode 310. The black matrix 320 corresponds to the source lines DLm-1 and DLm, the gate lines GLn-1 and GLn, and the switching element TFT to block light incident into the black matrix 320.

The electrochromic pattern 340 is formed on the first electrode 310, and includes a solvent layer 341 including pigment and an electrolyte layer 343. generating mobile ions. As illustrated, the electrochromic pattern 340 may further be formed on the black matrix 320.

The second electrode 330 is formed on the electrochromic pattern 340, and functions as a common electrode corresponding to the transparent and reflecting electrodes TE and RE formed on the pixel parts P. That is, the pixel electrode PE of the array substrate 200, the liquid crystal layer 400 and the second electrode 330 of the color filter substrate 300 form a liquid crystal capacitor.

In addition, the second electrode 330 is adjacent to the electrolyte layer 343 of the electrochromic pattern 340 to apply the second voltage to the electrochromic pattern 340. In particular, the color purity of the electrochromic pattern 340 is changed based on polarities of the mobile ions, which are changed based on the voltages applied to the first and second electrodes 310 and 330.

For example, when the mobile ions are hydroxyl ions (OH—) and the first voltage applied to the first electrode 310 has a greater level than the second voltage applied to the second electrode 330, the hydroxyl ions (OH—) are transported towards the first electrode 310, thereby increasing an ion density of the solvent layer 341 of the electrochromic pattern 340. Thus, color purity of the electrochromic pattern 340 is high.

When the first voltage applied to the first electrode 310 has a lower level than the second voltage applied to the second electrode 330, the ion density of the solvent layer 341 of the electrochromic pattern 340 is not changed. Thus, color purity of the electrochromic pattern 340 having unchanged ion density is lower than that of the electrochromic pattern 340 having increased ion density.

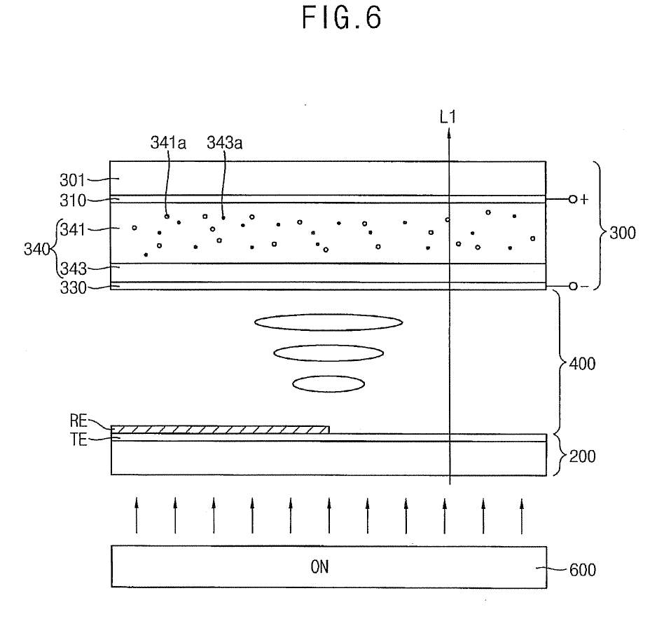

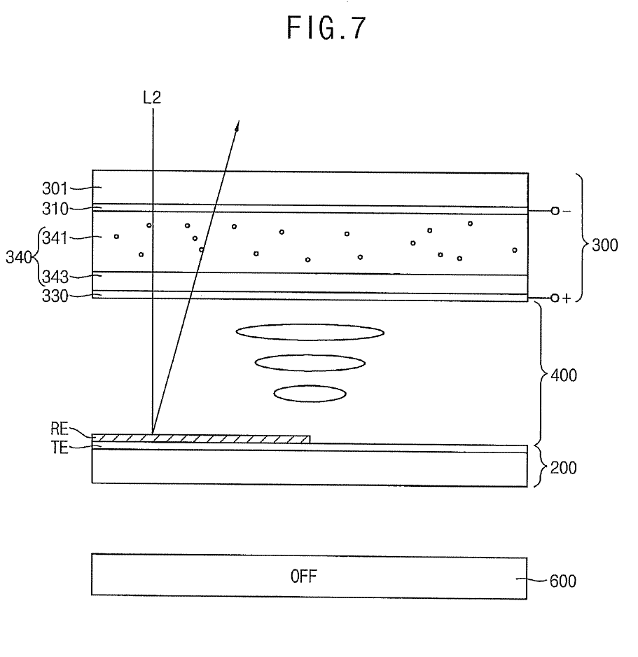

FIG. 6 is a cross-sectional view illustrating a transmission mode of the exemplary transflective LCD panel shown in FIG. 5. FIG. 7 is a cross-sectional view illustrating a reflection mode of the exemplary transflective LCD panel shown in FIG. 5.

Referring to FIGS. 5 to 7, the color filter substrate 300 of the transflective LCD panel includes the first electrode 310, the second electrode 330 and the electrochromic pattern 340 interposed between the first and second electrodes 310 and 330. The electrochromic pattern 340 includes the solvent layer 341 including the pigment particles 341a and the electrolyte layer 343 generating the mobile ions 343a.

The electrolyte layer 343 may be adjacent to either the first electrode 310 or the second electrode 330. In FIGS. 6 and 7, the electrolyte layer 343 includes an electrolyte material generating the mobile hydroxyl ions (OH—) 343a, and is adjacent to the second electrode 330, although alternate configurations and mobile ions would be within the scope of these embodiments.

Referring to FIG. 6, in the transmission mode, the first voltage + applied to the first electrode 310 has a higher level than the second voltage − applied to the second electrode 330. Thus, the electrolyte layer 343 is electrolyzed to generate the mobile hydroxyl ions (OH—) 343a. The mobile hydroxyl ions (OH—) 343a are transported toward the solvent layer 341 adjacent to the first electrode 310 receiving the first voltage + having the higher level so that the ion density of the solvent layer 341 is increased. Thus, the color purity of the electrochromic pattern 340 is increased.

In the transmission mode, an image is displayed on the pixel parts P using the first light L1 that is incident into the pixel parts P from the rear surface of the transflective LCD panel, such as from a backlight assembly 600. Therefore, in the transmission mode, the first light L1 passes through the electrochromic pattern 340 having the high ion density so that the image having the high color purity is displayed on the pixel parts P.

Referring to FIG. 7, in the reflection mode, the first voltage − applied to the first electrode 310 has lower level than the second voltage + applied to the second electrode 330. Thus, the electrolyte layer 343 is not electrolyzed so that the mobile hydroxyl ions (OH—) 343a are not generated. The ion density of the solvent layer 341 in the reflection mode is lower than that of the solvent layer 341 in the transmission mode so that the color purity of the electrochromic pattern 340 is low.

In the reflection mode, the image is displayed on the pixel parts P using the second light L2 that is incident into the pixel parts P from the front surface of the transflective LCD panel, such as from an exterior of the LCD panel. The second light L2 firstly passes through the electrochromic pattern 340, and reflected second light L2 that is reflected from the reflecting electrode RE secondly passes through the electrochromic pattern 340. Thus, in the reflection mode, the second light L2 passes through the electrochromic pattern 340 having the low color purity so that the pixel parts P display the image of the high color purity, which may be substantially the same as the color purity of the transmission mode.

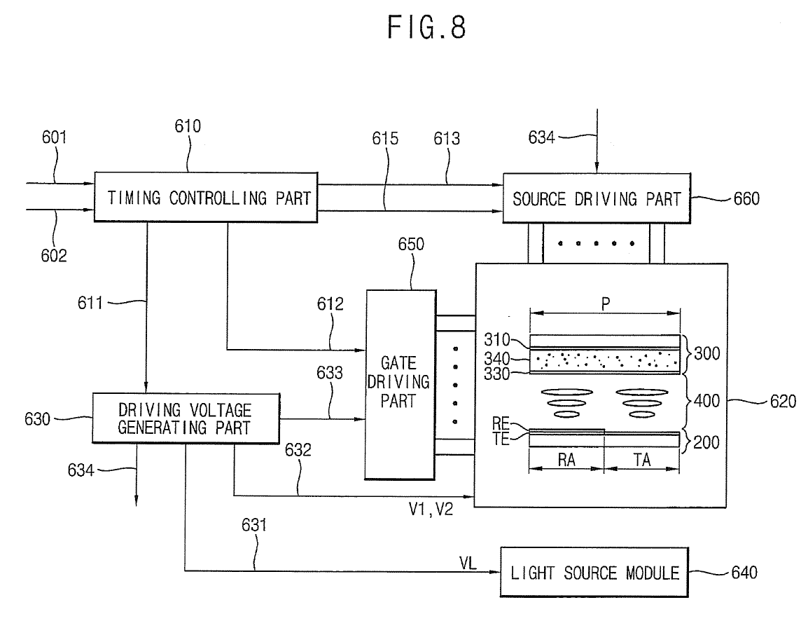

FIG. 8 is a block diagram illustrating an exemplary LCD device in accordance with another exemplary embodiment of the present invention.

Referring to FIG. 8, the LCD device includes a timing controlling part 610, an LCD panel 620, a driving voltage generating part 630, a light source module 640, a gate driving part 650, and a source driving part 660.

The timing controlling part 610 generates a first control signal 611, a second control signal 612, and a third control signal 613 based on externally provided control signals 601 to control an operation of the LCD device. The timing controlling part 610 applies externally provided data signals 602 to the source driving part 660 as data signals 615.

Particularly, the externally provided control signals 601 include a main clock signal MCLK, a horizontal synchronizing signal HSYNC, a data enable signal DE, a vertical synchronizing signal VSYNC, and a mode selection signal. The mode selection signal is used to select a transmission mode and a reflection mode. When the mode selection signal corresponds to the transmission mode, the LCD panel 620 displays an image using a first light L1 generated from the light source module 640. When the mode selection signal corresponds to the reflection mode, the LCD panel 620 displays the image using a second light L2 that is provided from an exterior to the LCD device, and the light source module 640 is turned off.

The first control signal 611 controls an operation of the driving voltage generating part 630. For example, the first control signal 611 controls the driving voltage generating part 630 to output a driving voltage for driving the light source module 640. The second control signal 612 controls an operation of the gate driving part 650, and includes a vertical start signal STV, a clock signal CK, and an output enable signal OE. The third control signal 613 controls an operation of the source driving part 660, and includes a horizontal start signal STH, an inversion signal REV, and a load signal TP.

The LCD panel 620 of FIG. 8 may be substantially the same as the transflective LCD panel in FIGS. 4 and 5. Referring to FIGS. 4, 5, and 8, the transflective LCD panel includes a plurality of pixel parts P, and each of the pixel parts P includes a switching element TFT, a transparent electrode TE, a reflecting electrode RE, a storage capacitor CST, a first electrode 310, a black matrix 320, a second electrode 330, and an electrochromic pattern 340. The switching element TFT, the transparent electrode TE, the reflecting electrode RE, and the storage capacitor CST are formed on the array substrate 200. The first electrode 310, the black matrix 320, the second electrode 330, and the electrochromic pattern 340 are formed on the color filter substrate 300. Thus, the same reference numerals will be used to refer to the same or like parts as those described in FIGS. 4 and 5 and any further description concerning the above elements will be omitted.

The driving voltage generating part 630 generates a first driving voltage, second driving voltages, third driving voltages, and a fourth driving voltage. The first driving voltage 631 is a voltage VL applied to the light source module 640 to drive the light source module 640. The second driving voltages 632 include first and second common voltages V1 and V2 applied to the LCD panel 620. The third driving voltages 633 include gate voltages VON and VOFF applied to the gate driving part 650. The fourth driving voltage 634 is a reference gray scale voltage VREF applied to the source driving part 660.

The first and second common voltages V1 and V2 are applied to the first and second electrodes 310 and 330, respectively. The second common voltage V2 is applied to a common electrode layer of the color filter substrate 300, which faces a pixel electrode PE of the array substrate 200. In the illustrated embodiment, the common electrode layer is the second electrode 330. A level of the first common voltage V1 applied to the first electrode 310 is controlled to change the mode of the LCD panel 620 into the reflection mode or the transmission mode.

The light source module 640 generates the first light L1 based on the first driving voltage 631 generated from the driving voltage generating part 630. The light source module 640 generates the first light L1 in the transmission mode, and does not generate the first light L1 in the reflection mode.

The gate driving part 650 generates the gate signals to the LCD panel 620 based on the second control signals 612 and the third driving voltages 633.

The source driving part 660 converts the data signal 615 generated from the timing controlling part 610 into an analog type data signal based on the third control signal 613. That is, the source driving part 660 changes the data signal 615 of a digital type into the analog type data signal based on the reference gray scale voltage 634 VREF from the driving voltage generating part 630, and applies the analog type data signal to the LCD panel 620.

In the transmission mode of the LCD device, the timing controlling part 610 controls the driving voltage generating part 630 so that the driving voltage generating part 630 applies a first common voltage +V1 having a higher level than the second common voltage V2 to the first electrode 310 of the LCD panel 620, and applies the first driving voltage 631 and the light source driving voltage VL, to the light source module 640.

Therefore, in the transmission mode, the electrochromic pattern 340 of each of the pixel parts P has a high color purity, and the pixel part P displays an image of the high color purity using the first light L1 generating from the light source module 640.

In the reflection mode of the LCD device, the timing controlling part 610 controls the driving voltage generating part 630 so that the driving voltage generating part 630 applies a first common voltage −V1 having a lower level than the second common voltage V2 to the first electrode 310 of the LCD panel 620, and does not apply the first driving voltage 631 and the light source driving voltage VL, to the light source module 640.

Therefore, in the reflection mode, the electrochromic pattern 340 of each of the pixel parts P has a low color purity, and the pixel part P displays an image using the second light L2 that is provided from an exterior to the LCD device. The second light L2 passes through the electrochromic pattern 340 two times so that the pixel part P displays the image having the high color purity in the reflection mode, which is substantially the same as that of the transmission mode.

An exemplary method of controlling color reproducibility of a color filter substrate of a transflective liquid crystal display panel is made possible by the above described liquid crystal display device. The method includes applying a first voltage to the first common electrode layer of the color filter substrate and applying a second voltage to the second common electrode layer of the color filter substrate, wherein the first voltage has a greater level than the second voltage in a transmission mode of the transflective liquid crystal panel, and the second voltage has a greater level than the first voltage in a reflection mode of the transflective liquid crystal panel. The exemplary method may include alternate steps and procedures according to alternate embodiments of the color filter substrate, the liquid crystal display panel including the color filter substrate, and the liquid crystal display device including the liquid crystal display panel. According to the present invention, the LCD device includes the electrochromic layer that changes the color purity in response to the mode to improve the color reproducibility of the reflection mode and the transmission mode.

In addition, a light hole formed in a color filter layer in a reflection region to improve a color reproducibility and a reflectivity may be omitted so that a stepped portion on such a light hole may be avoided, thereby improving optical characteristics of the color filter layer. In addition, a process for forming an overcoating to planarize the surface of the color filter layer may be omitted so that a manufacturing cost may be decreased, and a manufacturing process may be simplified.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A color filter substrate comprising:
a base substrate including a plurality of pixel parts;
a first common electrode layer on the base substrate receiving a first voltage;
a second common electrode layer facing the first common electrode layer and receiving a second voltage; and
a color filter layer interposed between the first and second common electrode layers and including a plurality of electrochromic patterns corresponding to the pixel parts, respectively, a color purity of the color filter layer being changed based on the first and second voltages, the color filter layer displaying an image of high color purity in a first mode transmitting a first light and displaying an image of low color purity in a second mode transmitting a second light.

2. The color filter substrate of claim 1, wherein the color filter layer comprises:
a solvent layer including a plurality of pigment particles; and
an electrolyte layer generating a plurality of mobile ions transported into the solvent layer in the first mode.

3. The color filter substrate of claim 2, wherein the electrochromic patterns comprises:
a first electrochromic pattern including a plurality of red pigment particles;
a second electrochromic pattern including a plurality of green pigment particles; and
a third electrochromic pattern including a plurality of blue pigment particles.

4. The color filter substrate of claim 1, further comprising a black matrix on the base substrate, the black matrix defining the pixel parts and blocking the first and second lights.

5. The color filter substrate of claim 4, wherein the black matrix is formed on the first common electrode layer.

6. The color filter substrate of claim 1, wherein the first voltage has a higher level than the second voltage in the first mode.

7. The color filter substrate of claim 6, wherein the first voltage has a lower level than the second voltage in the second mode.

8. A liquid crystal display panel comprising:
an array substrate including a plurality of pixel parts, each pixel part including a switching element, a transparent electrode, and a reflecting electrode, the transparent and reflecting electrodes electrically connected to the switching element;
a color filter substrate facing the array substrate, the color filter substrate including:
a first common electrode;
a second common electrode facing the first common electrode; and
an electrochromic layer interposed between the first and second common electrodes, a color purity of the color filter layer being changed based on a voltage difference between the first and second common electrodes; and
a liquid crystal layer interposed between the array substrate and the color filter substrate.

9. The liquid crystal display panel of claim 8, wherein the electrochromic layer comprises:
a solvent layer including a plurality of pigment particles; and
an electrochromic layer being electrolyzed to generate a plurality of mobile ions in a transmission mode of the liquid crystal display panel.

10. The liquid crystal display panel of claim 9, wherein the electrochromic layer comprises:
a first electrochromic pattern corresponding to a first pixel part of the pixel parts, the first electrochromic pattern including a first solvent layer having a first pigment particle and a first electrolyte layer;
a second electrochromic pattern corresponding to a second pixel part of the pixel parts, the second electrochromic pattern including a second solvent layer having a second pigment particle and a second electrolyte layer; and
a third electrochromic pattern corresponding to a third pixel part of the pixel parts, the third electrochromic pattern including a third solvent layer having a third pigment particle and a third electrolyte layer.

11. The liquid crystal display panel of claim 9, wherein the electrochromic layer displays an image of high color purity in a transmission mode transmitting a first light through the transparent electrode, and displays an image of low color purity in a reflection mode reflecting a second light from the reflecting electrode.

12. The liquid crystal display panel of claim 11, wherein the first common electrode receives a higher voltage level than the second common electrode in the transmission mode.

13. The liquid crystal display panel of claim 11, wherein the first common electrode receives a lower voltage level than the second common electrode in the reflection mode.

14. The liquid crystal display panel of claim 8, wherein the array substrate further comprises an organic insulating layer interposed between the switching element and the reflecting electrode, and the organic insulating layer corresponds to the reflecting electrode.

15. The liquid crystal display panel of claim 8, wherein the reflecting electrode divides each of the pixel parts into a reflection region and a transmission region, and a cell-gap of the liquid crystal layer in the reflection region is greater than a cell-gap of the liquid crystal layer in the transmission region.

16. A liquid crystal display device comprising:
a liquid crystal display panel including:
an array substrate including a switching element and a pixel part having a transparent electrode and a reflecting electrode, the transparent and reflecting electrodes being electrically connected to the switching element;
a color filter substrate facing the array substrate, the color filter substrate including a first common electrode, a second common electrode facing the first common electrode, and an electrochromic pattern interposed between the first and second common electrodes; and
a liquid crystal layer interposed between the array substrate and the color filter substrate;
a light source module on a rear surface of the liquid crystal display panel supplying the liquid crystal display panel with a first light in a transmission mode; and
a driving voltage generating part applying voltages to the first and second common electrodes so that the electrochromic pattern has a high color purity in the transmission mode transmitting the first light through the transparent electrode to display an image.

17. The liquid crystal display device of claim 16, wherein the driving voltage generating part applies a first voltage to the first common electrode and a second voltage to the second common electrode, and the first voltage has a higher level than the second voltage in the transmission mode.

18. The liquid crystal display device of claim 16, wherein the driving voltage generating part applies the voltages to the first and second common electrodes so that the electrochromic pattern has low color purity in a reflection mode, and the liquid crystal display panel displays an image using a second light reflected from the reflecting electrode.

19. The liquid crystal display device of claim 18, wherein the driving voltage generating part applies a first voltage to the first common electrode and a second voltage to the second common electrode, and the first voltage has a lower level than the second voltage in the reflection mode.

20. The liquid crystal display device of claim 18, wherein the driving voltage generating part applies a light source driving voltage to the light source module in the transmission mode, and does not apply the light source driving voltage to the light source module in the reflection mode.

21. A method of controlling color reproducibility of a color filter substrate of a transflective liquid crystal display panel, the color filter substrate having a first common electrode layer, a second common electrode layer, and an electrochromic layer interposed between the first and second common electrode layers, the method comprising:
applying a first voltage to the first common electrode layer of the color filter substrate; and,
applying a second voltage to the second common electrode layer of the color filter substrate;
wherein the first voltage has a greater level than the second voltage in a transmission mode of the transflective liquid crystal panel, and the second voltage has a greater level than the first voltage in a reflection mode of the transflective liquid crystal panel.

22. The method of claim 21, wherein the electrochromic layer includes a solvent layer including a plurality of pigment particles and an electrolyte layer, the method further comprising generating a plurality of mobile ions transported to the solvent layer from the electrolyte layer in the transmission mode.
